(19) United States
(12) Patent Application Publication
(10) Pub. No.: US 2024/0041114 A1
(43) Pub. Date: Feb. 8, 2024

(54) AEROSOL-FORMING APPARATUS AND HEATING ASSEMBLY

(71) Applicant: Hainan Moore Brothers Technology Co., Ltd., Hainan (CN)

(72) Inventors: Xiangan LU, Hainan (CN); Hao WEN, Hainan (CN); Naian WEI, Hainan (CN); Zhenlong JIANG, Hainan (CN); Lusheng JIANG, Hainan (CN); Riming FANG, Hainan (CN)

(21) Appl. No.: 18/360,769

(22) Filed: Jul. 27, 2023

(30) Foreign Application Priority Data
Aug. 8, 2022 (CN) 202210945264.9

(51) Int. Cl. A24F 40/46; H05B 3/42

(52) U.S. Cl. CPC A24F 40/46; H05B 3/42; A24F 40/20

(57) ABSTRACT

A heating assembly, used in an aerosol-forming apparatus, includes: a heating rod; a base film at least partially wrapping the heating rod; a heating film arranged between the base film and the heating rod; and two electrode leads. Each electrode lead of the two electrode leads has a conduction portion arranged between the base film and the heating rod and connected to the heating film.

### CROSS-REFERENCE TO PRIOR APPLICATION

Priority is claimed to Chinese Patent Application No. 202210945264.9, filed on Aug. 8, 2022, the entire disclosure of which is hereby incorporated by reference herein.

### FIELD

The present invention relates to the field of vaporization, and more specifically, to an aerosol-forming apparatus and a heating assembly.

### BACKGROUND

A heat-not-burning aerosol-forming apparatus is an electronic device that heats an aerosol-forming substrate in a manner of heat-not-burning. A core component of the heat-not-burning aerosol-forming apparatus is a heating body. The heating body heats the aerosol-forming substrate to a temperature at which an aerosol can be formed but not enough to burn, so that the aerosol-forming substrate generates an aerosol required by a user without burning.

An existing heating body is usually formed by winding and wrapping a film tape around a heating rod. The film tape is internally provided with a heating film and an inner conductive film, and the film tape is externally provided with an outer conductive film. The inner conductive film and the outer conductive film are connected through a conduction hole opened on the film tape. When the conduction hole is poor in process, the film tape has risks of cracking and breaking. Second, the outer conductive film is usually connected to an electrode lead in a brazing process. The brazing process is complicated, and a brazing material and the outer conductive film are exposed and easily oxidized and corroded by the aerosol-forming substrate. In addition, the brazing material is usually a precious metal with a good conductivity, such as silver paste, which is required in a large amount, and costs are high.

### SUMMARY

In an embodiment, the present invention provides a heating assembly, used in an aerosol-forming apparatus, comprising: a heating rod; a base film at least partially wrapping the heating rod; a heating film arranged between the base film and the heating rod; and two electrode leads, wherein each electrode lead of the two electrode leads comprises a conduction portion arranged between the base film and the heating rod and connected to the heating film.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a top view of a heating assembly according to a first embodiment of the present invention;

FIG. 2 a schematic longitudinal cross-sectional structural view of the heating assembly along A-A shown in FIG. 1;

FIG. 3 is a top view of a heating assembly according to a second embodiment of the present invention;

FIG. 4 is a schematic longitudinal cross-sectional structural view of a heating assembly according to a third embodiment of the present invention;

FIG. 5 is a three-dimensional schematic structural diagram of an aerosol-forming apparatus accommodating an aerosol-forming substrate according to some embodiments of the present invention; and

FIG. 6 is a schematic longitudinal cross-sectional structural view of the aerosol-forming apparatus accommodating the aerosol-forming substrate shown in FIG. 5.

### DETAILED DESCRIPTION

In an embodiment, the present invention provides an improved heating assembly and an aerosol-forming apparatus having the heating assembly for the foregoing defects in the related art.

In an embodiment, the present invention provides a heating assembly, used in an aerosol-forming apparatus. The heating assembly includes:
a heating rod;
a base film, at least partially wrapping the heating rod;
a heating film, arranged between the base film and the heating rod; and
two electrode leads.

Each electrode lead includes a conduction portion, and the conduction portion is arranged between the base film and the heating rod and connected to the heating film.

In some embodiments, the base film, the heating film, and the two electrode leads are sintered together by co-firing.

In some embodiments, the heating assembly further includes two conductive films, and the two conductive films are arranged between the base film and the heating rod and respectively connected to the heating film and the two electrode leads.

In some embodiments, the base film, the heating film, the two conductive films, and the two electrode leads are sintered together by co-firing.

In some embodiments, each of the conductive films and the heating film are at least partially overlapped with each other.

In some embodiments, each of the conductive films and the conduction portion are at least partially overlapped with each other.

In some embodiments, the heating assembly further includes a fixing base arranged on one end of the heating rod. In some embodiments, a gap is formed between the heating film and the fixing base.

In some embodiments, the base film is entirely located outside the fixing base, or the base film is partially accommodated in the fixing base.

In some embodiments, the base film is formed by winding a flexible film tape around the heating rod and then sintering the flexible film tape.

In some embodiments, the heating rod includes a tip portion, a main body portion, and an assembling portion that are sequentially arranged in the axial direction of the heating rod, and the base film wraps the main body portion.

In some embodiments, the main body portion is in the shape of cylinder, and the tip portion is in the shape of cone or truncated cone.

In some embodiments, the base film further wraps at least a part of the assembling portion and/or at least a part of the tip portion.

In some embodiments, a concave hole is concavely formed on the end surface of the assembling portion that faces away from the tip portion.

In some embodiments, the diameter or the width of the conduction portion is 0.2 mm to 1 mm.

In some embodiments, the heating assembly further includes two conductive reinforcing tapes arranged in the base film and respectively connected to the two electrode leads.

In some embodiments, the two electrode leads present an angle in the circumferential direction of the heating rod, and one of the conductive reinforcing tapes is arranged on the side of the corresponding electrode lead that is farther from the other electrode lead; or

In some embodiments, the two electrode leads are distributed at an angle of 180 degrees in the circumferential direction of the heating rod.

In some embodiments, the heating assembly further includes a protective layer arranged on the outer surface of the base film, where the protective layer has a smooth dense surface.

The present invention further provides an aerosol-forming apparatus including the heating assembly described in any one of the foregoing items.

Implementation of the present invention at least has the following beneficial effects: The heating film and the conduction portions of the electrode leads are all located inside the base film, and are not exposed with no risk of oxidation and corrosion, and the electrode leads do not need to be connected in a welding process. In addition, there is no need to open a hole on the base film, thereby reducing risks of cracking.

In order to have a clearer understanding of the technical features, the objectives, and the effects of the present invention, specific implementations of the present invention are described in detail with reference to the accompanying drawings. In the following description, many specific details are described for thorough understanding of the present invention. However, the present invention may be implemented in many other manners different from those described herein. A person skilled in the art may make similar improvements without departing from the connotation of the present invention. Therefore, the present invention is not limited to the specific embodiments disclosed below.

In the description of the present invention, it should be understood that orientation or position relationships indicated by the terms such as “longitudinal direction”, “axial direction”, “upper”, “lower”, “top”, “bottom”, “inner”, and “outer” are based on orientation or position relationships shown in the accompanying drawings or orientation or position relationships of usual placement of the present invention product when used, and are used only for ease and brevity of illustration and description of the present invention, rather than indicating or implying that the mentioned apparatus or component needs to have a particular orientation or needs to be constructed and operated in a particular orientation. Therefore, such terms should not be construed as limiting of the present invention.

In addition, the terms “first” and “second” are used merely for the purpose of description, and shall not be construed as indicating or implying relative importance or implying a quantity of indicated technical features. Therefore, features defining “first” and “second” can explicitly or implicitly include at least one of the features. In the description of the present invention, unless otherwise specifically limited, “a plurality of” means at least two, for example, two or three.

In the present invention, unless otherwise explicitly specified or limited, the terms “mounted”, “connected”, “connection”, and “fixed” should be understood broadly, for example, which may be fixed connections, detachable connections or integral connections; or the connection may be a mechanical connection or an electrical connection; or the connection may be a direct connection, an indirect connection through an intermediary, or internal communication between two elements or mutual action relationship between two elements, unless otherwise specified explicitly. A person of ordinary skill in the art may understand the specific meanings of the foregoing terms in the present invention according to specific situations.

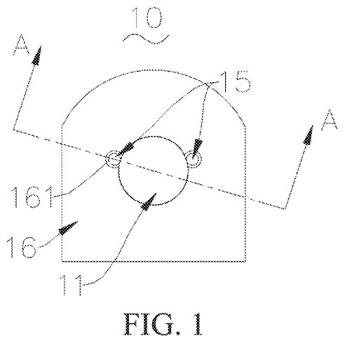

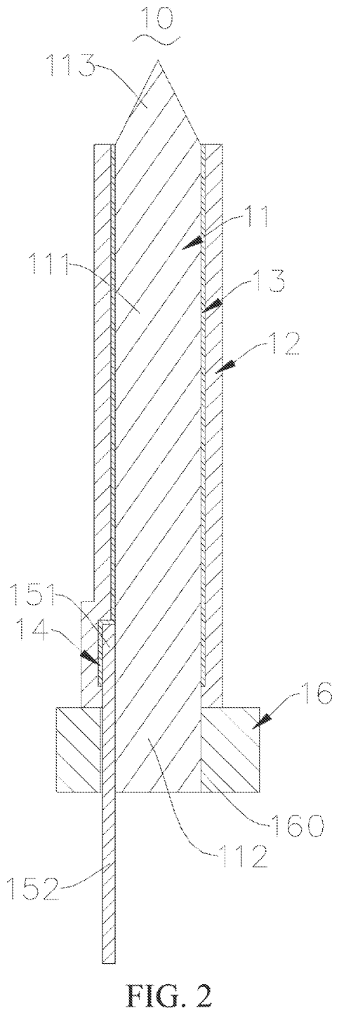

FIG. 1 and FIG. 2 shows a heating assembly 10 according to a first embodiment of the present invention. The heating assembly 10 may be inserted into an aerosol-forming substrate, and bake and heat the aerosol-forming substrate after being energized. The heating assembly 10 includes a heating rod 11, a base film 12 at least partially wrapping the heating rod 11, a heating film 13 arranged between the base film 12 and the heating rod 11, and two electrode leads 15 respectively connected to two electrodes of the heating film (13). The two electrode leads 15 are both at least partially wrapped in the base film 12, and may be formed with the heating film 13 by co-firing in a simple process. The electrode leads 15 do not need to be connected in a brazing process, thereby increasing efficiency and reducing costs.

The heating rod 11 is configured to provide rigid support for the base film 12, and may be in the shape of column or may be in the shape of sheet; and the heating rod 11 may be a solid structure or may have a hollow structure. This is not specifically limited. The heating rod 11 may be made of a conductive material, such as metal; or may be made of a non-conductive insulating material, such as ceramics or high temperature resistant plastic. The material and structure of the heating rod 11 are usually determined based on a thermal conductivity. Usually, when the heating rod 11 is made of a material with a high thermal conductivity, the heating assembly 10 has a higher energy consumption; and when the heating rod 11 has a solid column structure, the heating assembly 10 has a higher energy consumption.

In this embodiment, the heating rod 11 is a solid cylinder, and is made of a ceramic material. The diameter of the heating rod 11 may be 1.5 mm to 3 mm, for example, 2 mm. A total length of the heating rod 11 may be 14 mm to 30 mm. The heating rod 11 may include a tip portion 113, a main body portion 111, and an assembling portion 112 arranged sequentially from top to bottom in the axial direction. The base film 12 wraps the main body portion 111 of the heating rod 11. In another embodiment, the base film 12 may wrap the main body portion 111 and at least a part of the assembling portion 112, or the base film 12 may wrap the main body portion 111 and at least a part of the tip portion 113, or the base film 12 may wrap the main body portion 111, at least a part of the assembling portion 112, and at least a part of the tip portion 113. The tip portion 113 may be in the shape of cone, truncated cone, or the like, and the heating assembly 10 is inserted into the aerosol-forming substrate through the tip portion 113.

The base film 12 may be wrapped around the heating rod 11 in a manner of winding. In some embodiments, the base film 12 may be formed by winding a flexible thin film tape around the heating rod 11 and then sintering the flexible thin film tape, and the flexible thin film tape may be formed in a tape casting process. The base film 12 may be made of one or any combination of microcrystalline glass, glass-ceramics (for example, calcium borosilicate glass-silicon oxide), low temperature ceramics (for example, tin-barium borate ceramics, zirconium-barium borate ceramics), and the like, given that the base film 12 can be sintered at less than 1000° C. In one embodiment, the base film 12 is made of a glass-ceramic material. When the base film 12 is made of a glass and/or ceramic material, the outer surface of the base film 12 may further have a high surface smoothness, and the smooth surface is easy to clean, thereby reducing miscellaneous tastes and a burnt taste caused by soot bonded to the outer surface of the base film 12 after long-term use, and providing a good experience for consumers.

In some embodiments, the outer surface of the base film 12 may further be provided with a protective layer, such as a glaze layer. The protective layer may be formed by coating the outer surface of the base film 12 with ceramics, glass and other paste and then sintering the paste at a high temperature. The protective layer has a smooth dense surface that can effectively reduce residues of soot on the heating assembly 10 during heating, effectively reduce corrosion of the residual soot on the heating assembly 10, and extend the service life of the heating assembly 10.

The heating film 13 is configured to generate heat after being energized, to heat the aerosol-forming substrate. The heating film 13 is arranged on the inner side surface of the base film 12 and closely abuts the heating rod 11. The heating film 13 may be made of a material with a high resistivity, to generate more heat after being energized.

In some embodiments, the heating assembly 10 further includes two conductive films 14 arranged inside the base film 12, and the heating film 13 is connected to the two electrode leads 15 through the two conductive films 14, so that a more reliable circuit connection is formed between the electrode leads 15 and the heating film 13. In this embodiment, the two conductive films 14 are both connected to the lower end of the heating film 13. The conductive film 14 may be made of a material with a low resistivity, such as one or more of nickel, chromium, silver. The conductive film 14 does not generate heat or generates little heat after being energized. The electrode lead 15 is usually a wire electrode with a low resistivity, such as a silver wire.

The two electrode leads 15 are respectively in direct contact conduction with the two conductive films 14 in a manner of overlapping, and the two electrode leads 15 present an angle (not an angle of 180 degrees) in the circumferential direction of the heating rod 11. In another embodiment, the two electrode leads 15 may alternatively be located on two opposite sides of the heating rod 11 in the circumferential direction, that is, the two electrode leads 15 present an angle of 180 degrees in the circumferential direction of the heating rod 11. In one embodiment, the heating film 13 and the conductive films 14 are all formed on the base film 12 in a manner of silk screen printing, the heating film 13 and the conductive films 14 are overlapped in the manner of silk screen printing, the conductive films 14 and the electrode leads 15 are overlapped in a manner of film rolling, and then the base film 12, the heating film 13, the conductive films 14, and the electrode leads 15 are sintered and formed together in a co-firing process. The forming process is simple and has few process steps. A manner of overlapping can increase the contact area between the heating film 13 and the conductive films 14 and the contact area between the conductive films 14 and the electrode leads 15, thereby improving reliability of the electrical connection.

Each electrode lead 15 has a conduction portion 151 wrapped in the base film 12 and an outward portion 152 extending out of the base film 12 for a connection to an external power supply. The conduction portion 151 is connected to the conductive film 14 and may be overlapped on the conductive film 14 and in direct contact conduction with the conductive film 14. The conduction portion 151 may be a round wire, a flat wire, a square wire, or multi-stranded wire, or may be a round wire with a flat end, or the like. This is not specifically limited. The diameter or the width of the conduction portion 151 is about 0.2 mm to 1 mm. In this embodiment, the conduction portions 151, the heating film 13, and the conductive films 14 are all entirely located in the base film 12, and are not exposed with no risk of oxidation and corrosion, thereby increasing the service life of the heating assembly 10. In addition, there is no need to open a hole on the base film 12, thereby reducing risks of cracking.

Further, the heating assembly 10 may further include a fixing base 16 arranged on the assembling portion 112 of the heating rod 11. The fixing base 16 may be made of a high temperature resistant material such as ceramics or PEEK (polyether ether ketone). The fixing base 16 is provided with an assembling hole 160 for accommodating the assembling portion 112 and two wire passages 161 for respectively being passed by the two electrode leads 15. The assembling portion 112 matches the assembling hole 160, to implement mounting and fixing of the heating rod 11. In this embodiment, the assembling hole 160 is a straight through hole and may extend upward, in the longitudinal direction, from the lower end surface of the fixing base 16 to the upper end surface of the fixing base 16, and the wire passages 161 are concavely formed on the hole wall of the assembling hole 160. The outer wall surface of the assembling portion 112 and the hole wall surface of the assembling hole 160 may be sintered and fixed after bonding by a glass glaze or a ceramic material. In another embodiment, the fixing base 16 and the heating rod 11 may be integrally formed.

The lower end surface of the base film 12 may abut the upper end surface of the fixing base 16, or there may be a specific gap between the lower end surface of the base film 12 and the upper end surface of the fixing base 16. In other embodiments, the lower end of the base film 12 may alternatively be partially embedded in the fixing base 16. There is a specific distance between the lower end surface of the heating film 13 and the upper end surface of the fixing base 16, making it convenient for heat insulation and reducing heat transfer from the heating film 13 to the fixing base 16.

In one embodiment, the heating assembly 10 in this embodiment may be prepared by adopting the following process steps:

A flexible thin film tape is formed in a tape casting process, and then a heating film blank and a conductive film blank are separately prepared on the flexible thin film tape in a manner of silk screen printing or the like.

The heating rod 11, the fixing base 16, and the two electrode leads 15 are assembled, and first sintering and fixing is performed after the assembly is completed.

Film rolling is performed on the flexible thin film tape with the heating film blank and the conductive film blank, so that the heating rod 11 and the two electrode leads 15 are wrapped by the flexible thin film tape, and second sintering is performed after the film rolling is completed. After the sintering is completed, the flexible thin film tape forms the base film 12, and the heating film blank and the conductive film blank respectively form the heating film 13 and the conductive film 14.

Further, after the second sintering, third sintering may be further performed after dip-coating the outer surface of the base film 12 with a heat-spreading material, to form a heat-spreading layer. The heat-spreading layer is provided to make distribution of a temperature field of the heating assembly 10 more uniform.

Further, after the third sintering, fourth sintering may be further performed after dip-coating the outer surface of the heat-spreading layer with a protective layer material, to form a protective layer, so that the heating assembly 10 has a smooth dense outer surface.

The process steps of the heating assembly 10 in this embodiment are fewer and less difficult to operate, thereby improving efficiency and a qualification rate.

It may be understood that, in another embodiment, film rolling may be alternatively first performed on the heating rod 11 and the two electrode leads 15, and then the heating rod 11 and the two electrode leads 15 are assembled on the fixing base 16 after the film rolling is completed. In this case, the lower end surface of the base film 12 may further provide a limiting function.

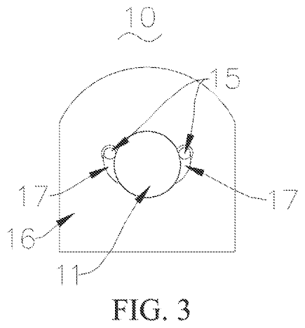

FIG. 3 shows a heating assembly 10 in a second embodiment of the present invention. A main deference between the heating assembly 10 in the second embodiment and that in the foregoing first embodiment lies in that: the heating assembly 10 in this embodiment further includes two conductive reinforcing tapes 17. The two conductive reinforcing tapes 17 are arranged in a base film 12 and respectively connected to two electrode leads 15, can reduce risks of cracking of the base film 12, and can improve reliability of an electrical connection between the electrode leads 15 and conductive films 14. Specifically, in this embodiment, a conductive reinforcing tape 17 is arranged on the side (far side) of the corresponding electrode lead 15 that is farther from another electrode lead 15, and is connected to the corresponding electrode lead 15 and conductive film 14. The conductive reinforcing tape 17 may be made of a material with a low resistivity, such as one or more of nickel, chromium, silver, and other conductive materials. In preparation, after the electrode leads 15 are assembled on the heating rod 11, the far sides of the electrode leads 15 may be coated with a thin layer of conductive paste such as silver paste, the conductive paste forms the conductive reinforcing tapes 17 after sintering.

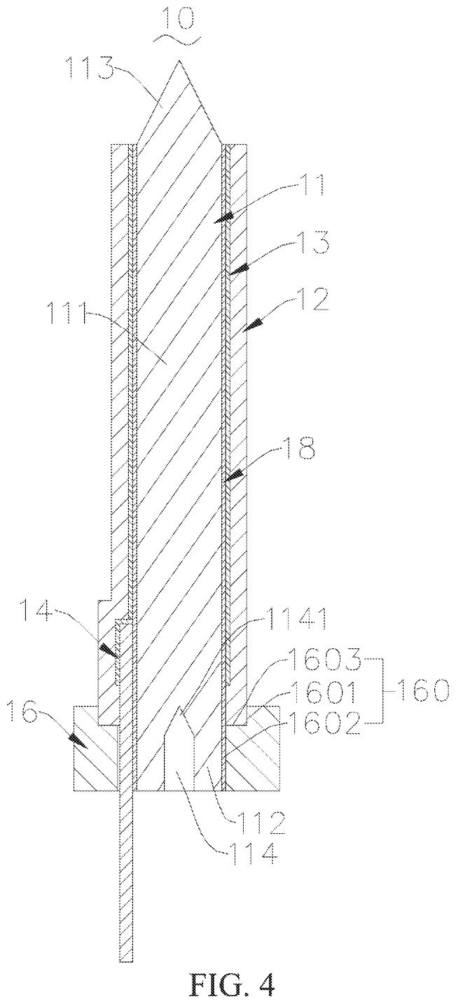

FIG. 4 shows a heating assembly 10 in a third embodiment of the present invention. A main deference between the heating assembly 10 in the third embodiment and that in the foregoing first embodiment lies in that: the heating rod 11 in this embodiment is made of a conductive material such as metal. Correspondingly, the heating assembly 10 in this embodiment further includes an insulating layer 18, and the insulating layer 18 is arranged on the outer side surface of the heating rod 11, to insulate the heating rod 11 from a heating film 13, conductive films 14, and electrode leads 15.

In addition, the difference between this embodiment and the foregoing first embodiment further lies in that: a base film 12 in this embodiment wraps a main body portion 111 and a part of an assembling portion 112, that is, the lower end of the base film 12 is partially embedded in a fixing base 16. Correspondingly, an assembling hole 160 in this embodiment is a stepped hole, and the assembling hole 160 may include a first hole section 1601 at an upper part and a second hole section 1602 at a lower part. The cross-sectional dimension of the first hole section 1601 is larger than the cross-sectional dimension of the second hole section 1602. The lower end of the base film 12 is accommodated in the first hole section 1601, and the lower end surface of the base film 12 may abut the step surface 1603 between the first hole section 1601 and the second hole section 1602, so that the base film 12 can further provide a limiting function during assembly. In preparation of the heating assembly 10 in this embodiment, film rolling may be first performed on the heating rod 11 and the two electrode leads 15, and then the heating rod 11 and the two electrode leads 15 are assembled on the fixing base 16 after the film rolling is completed.

In addition, the difference between this embodiment and the foregoing first embodiment further lies in that: the bottom surface of the assembling portion 112 in this embodiment may further extend upward to form a concave hole 114, and the concave hole 114 can reduce a heat capacity of the heating rod 11 and reduce energy consumption of the heating assembly 10. Further, in this embodiment, the concave hole 114 may be coaxially arranged with the heating rod 11 and may be in the shape same as or similar to the heating rod 11, which is conducive to uniform heat distribution. Specifically, the concave hole 114 is a cylindrical hole extending in the longitudinal direction, the head 1141 of the concave hole 114 that faces a tip portion 113 is a conical hole, and the conical degree of the conical hole is the same as the conical degree of the tip portion 113.

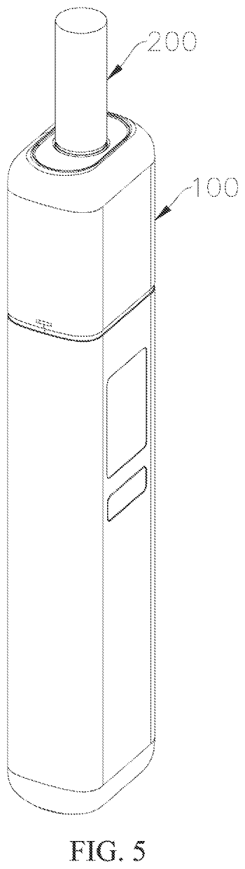

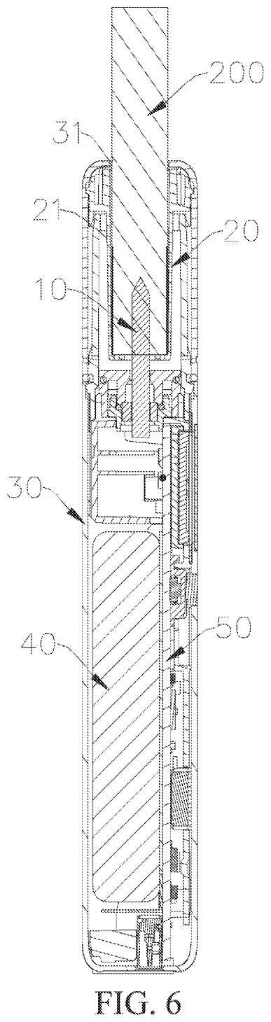

FIG. 5 and FIG. 6 shows an aerosol-forming apparatus 100 in some embodiments of the present invention. The aerosol-forming apparatus 100 may be configured to bake and heat, at a low temperature, an aerosol-forming substrate 200 that is inserted into the aerosol-forming apparatus 100, to release an aerosol extract from the aerosol-forming substrate 200 in a non-combustible state. The aerosol-forming substrate 200 may be in the shape of cylinder, and the aerosol-forming apparatus 100 may be substantially in the shape of square cylinder. The aerosol-forming substrate 200 is removably inserted into the aerosol-forming apparatus 100 for being conveniently removed and replaced with a new aerosol-forming substrate 200 after heating is completed. It may be understood that, in other embodiments, the aerosol-forming apparatus 100 is not limited to the shape of square column, and may alternatively be in the shape of cylinder, elliptical column, or other shapes. The aerosol-forming substrate 200 is also not limited to the shape of cylinder, and may alternatively be in the shape of elliptical column or other shapes.

The aerosol-forming apparatus 100 includes a housing 30 and a heating assembly 10, an accommodating pipe 20, a battery 40, and a main board 50 that are accommodated in the housing 30. The heating assembly 10 may be the heating assembly in any one of the foregoing embodiments. The inner wall surface of the accommodating pipe 20 defines an accommodating space 21 configured to accommodate the aerosol-forming substrate 200, the top wall of the housing 30 is provided with an insertion hole 31 for insertion of the aerosol-forming substrate 200, and the aerosol-forming substrate 200 may be inserted into the accommodating space 21 through the insertion hole 31. The upper end of the heating assembly 10 may extend into the accommodating space 21 and be inserted into the aerosol-forming substrate 200, configured to bake and heat the aerosol-forming substrate 200 after being energized and generating heat. The main board 50 is separately electrically connected to the battery 40 and the heating assembly 10. A related control circuit is arranged on the main board 50, and can control on/off between the battery 40 and the heating assembly 10 using a switch arranged on the housing 30.

It may be understood that the foregoing technical features may be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly, used in an aerosol-forming apparatus, comprising:
a heating rod;
a base film at least partially wrapping the heating rod;
a heating film arranged between the base film and the heating rod; and
two electrode leads,
wherein each electrode lead of the two electrode leads comprises a conduction portion arranged between the base film and the heating rod and connected to the heating film.

2. The heating assembly of claim 1, wherein the base film, the heating film, and the two electrode leads are sintered together by co-firing.

3. The heating assembly of claim 1, further comprising:
two conductive films,
wherein the two conductive films are arranged between the base film and the heating rod and respectively connected to the heating film and the two electrode leads.

4. The heating assembly of claim 3, wherein the base film, the heating film, the two conductive films, and the two electrode leads are sintered together by co-firing.

5. The heating assembly of claim 3, wherein each of the two conductive films and the heating film are at least partially overlapped with each other.

6. The heating assembly of claim 3, wherein each of the two conductive films and the conduction portion are at least partially overlapped with each other.

7. The heating assembly of claim 1, further comprising:
a fixing base arranged on one end of the heating rod.

8. The heating assembly of claim 7, wherein a gap is formed between the heating film and the fixing base.

9. The heating assembly of claim 7, wherein the base film is located entirely outside the fixing base, or the base film is partially accommodated in the fixing base.

10. The heating assembly of claim 1, wherein the base film is formed by winding a flexible film tape around the heating rod and then sintering the flexible film tape.

11. The heating assembly of claim 1, wherein the heating rod comprises a tip portion, a main body portion, and an assembling portion that are sequentially arranged in an axial direction of the heating rod, and
wherein the base film wraps the main body portion.

12. The heating assembly of claim 11, wherein the main body portion is in a shape of a cylinder, and the tip portion is in a shape of a cone or truncated cone, and
wherein the base film wraps at least a part of the assembling portion and/or at least a part of the tip portion.

13. The heating assembly of claim 11, wherein a concave hole is concavely formed on an end surface of the assembling portion that faces away from the tip portion.

14. The heating assembly of claim 1, wherein a diameter or a width of the conduction portion is 0.2 mm to 1 mm.

15. The heating assembly of claim 1, further comprising:
two conductive reinforcing tapes arranged in the base film and respectively connected to the two electrode leads.

16. The heating assembly of claim 15, wherein the two electrode leads present an angle in a circumferential direction of the heating rod, and one conductive reinforcing tape of the two conductive reinforcing tapes is arranged on a side of a corresponding electrode lead of the two electrode leads that is farther from an other electrode lead of the two electrode leads, or
wherein the two electrode leads are distributed at an angle of 180 degrees in a circumferential direction of the heating rod.

17. The heating assembly of claim 1, further comprising:
a protective layer arranged on an outer surface of the base film,
wherein the protective layer has a smooth dense surface.

18. An aerosol-forming apparatus, comprising:
the heating assembly of claim 1.
